(19) United States
(12) Patent Application Publication
(10) Pub. No.: US 2025/0176000 A1
(43) Pub. Date: May 29, 2025

(54) SYSTEMS AND METHODS FOR RESOURCE INDICATION

(71) Applicant: ZTE Corporation, Shenzheng (CN)

(72) Inventors: Wei CAO, Shenzhen (CN); Nan ZHANG, Shenzhen (CN); Shuang ZHENG, Shenzhen (CN); Ziyang LI, Shenzhen (CN); Linxi HU, Shenzhen (CN)

(73) Assignee: ZTE Corporation, Shenzheng (CN)

(21) Appl. No.: 19/037,758

(22) Filed: Jan. 27, 2025

Related U.S. Application Data
(63) Continuation of application No. PCT/CN2023/074094, filed on Feb. 1, 2023.

(51) Int. Cl. H04W 72/25; H04W 16/28; H04W 72/0453

(52) U.S. Cl. CPC H04W 72/25; H04W 16/28; H04W 72/0453

(57) ABSTRACT

Presented are systems and methods for resource indication. A network node may receive at least one signaling that includes side control information (SCI) from a wireless communication node. The network node may perform communication via at least one link between the network node and a wireless communication device or the wireless communication node, according to the SCI.

### CROSS-REFERENCE TO RELATED APPLICATION

This application claims the benefit of priority under 35 U.S.C. § 120 as a continuation of PCT Patent Application No. PCT/CN2023/074094, filed on Feb. 1, 2023, the disclosure of which is incorporated herein by reference in its entirety.

### TECHNICAL FIELD

The disclosure relates generally to wireless communications, including but not limited to systems and methods for resource indication.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A network node (e.g., a network controlled repeater (NCR), a reconfigurable intelligent surface (RIS)) may receive at least one signaling that includes side control information (SCI) from a wireless communication node (e.g., a base station (BS)). The network node may perform communication (e.g., transmission and/or reception) via at least one link between the network node and a wireless communication device (e.g., a user equipment (UE)) or the wireless communication node, according to the SCI. The at least one link may include at least one of: a first forwarding link from the wireless communication node to the network node; a second forwarding link from the network node to the wireless communication node; a third forwarding link from the network node to the wireless communication device; or a fourth forwarding link from the wireless communication device to the network node.

In some embodiments, the SCI may comprise at least one of: beam information comprising L indications each to indicate a respective beam to be used in forwarding, where L is an integer value greater than or equal to 0; time information comprising T indications each to indicate a respective applicable time for at least one beam, where T is an integer value greater than or equal to 0; time unit information comprising U indications each to indicate a respective time length of a symbol or a slot applicable for at least one beam, where U is an integer value greater than or equal to 0; frequency information comprising F indications each to indicate a respective applicable frequency resource for at least one beam, where F is an integer value greater than or equal to 0; polarization information comprising P indications each to indicate a respective applicable polarization for at least one beam, where P is an integer value greater than or equal to 0; forwarding direction information comprising D indications each to indicate a respective forwarding direction of at least one beam, where D is an integer value greater than or equal to 0; or power information comprising G indications each to indicate a respective forwarding power of at least one beam, where G is an integer value greater than or equal to 0.

In some embodiments, the at least one signaling may comprise at least one of: a radio resource control (RRC) signaling, a medium access control control element (MAC CE) signaling, or a downlink control information (DCI) signaling. A first format of the at least one signaling may comprise: a respective field for each indication of the L, T, U, F, P, D and G indications. A second format of the at least one signaling may comprise: a respective list for each group of the L indications, the T indications, the U indications, the F indications, the P indications, the D indications, and the G indications, respectively.

In some embodiments, a third format of the at least one signaling may comprise: a respective group of indications for each of N forwarding resources. N can be an integer value corresponding to a maximum value amongst L, T, U, F, P, D and G. Each of the groups of indications may include a respective indication from each of at least one of: the L indications, the T indications, the U indications, the F indications, the P indications, the D indications, or the G indications.

In some embodiments, a fourth format of the at least one signaling may comprise at least one of: a respective field for each indication of at least some of the L, T, U, F, P, D and G indications; or a respective group of indications for each of at least some of N forwarding resources. N can be an integer value corresponding to a maximum value amongst any two or more of L, T, U, F, P, D and G. Each of the groups of indications may include a respective indication from each of at least one of: the L indications, the T indications, the U indications, the F indications, the P indications, the D indications, or the G indications.

In some embodiments, L can be an integer value that is: defined or configured for a plurality of network nodes; defined or configured according to a capability of the network node; or equal to zero.

In some embodiments, T=L, which may represent a 1-to-1 mapping to associate each beam with a respective applicable time; T=1, which may represent a L-to-1 mapping to associate the L beams with a common time, or which may have a time resource index indicating at least one applicable time; or T=0.

In some embodiments, U=1, which may represent a L-to-1 mapping to associate the L beams with a common time unit; U=0; or U=L, which may represent a 1-to-1 mapping to associate each beam with a respective applicable time unit.

In some embodiments, F=L, which may represent a 1-to-1 mapping to associate each beam and with a respective applicable frequency; F=1, which may represent a L-to-1 mapping to associate the L beams with a common frequency; F=0; or 0<F<L, which may represent associating a common frequency resource with some of the L beams.

In some embodiments, P=L, which may represent a 1-to-1 mapping to associate each beam with a respective applicable polarization; P=1, which may represent a L-to-1 mapping to associate the L beams with a common polarization; P=0; or 0<P<L, which may represent associating a common polarization with some of the L beams.

In some embodiments, D=L, which may represent a 1-to-1 mapping to associate each beam with a respective applicable forwarding direction; D=1, which may represent a L-to-1 mapping to associate the L beams with a common forwarding direction; D=0; or 0<D<L, which may represent associating a common forwarding direction with some of the L beams.

In some embodiments, G=L, which may represent a 1-to-1 mapping to associate each beam with a respective applicable power indication; G=1, which may represent a L-to-1 mapping to associate the L beams with a common power indication; G=0; or 0<G<L, which may represent associating a common power indication with some of the L beams.

In some embodiments, the network node may determine an actual number of beams (L1), according to: (i) a number of time indications that are determined to be valid, or (ii) a number of applicable times indicated by a time resource index. The network node may determine an actual number of beams (L1), according to a radio resource control (RRC) or medium access control control element (MAC CE) signaling. The network node may determine an actual number of time (T1), according to a radio resource control (RRC) or medium access control control element (MAC CE) signaling.

In some embodiments, a wireless communication node (e.g., a BS) may send at least one signaling that includes side control information (SCI) to a network node (e.g., a network controlled repeater (NCR), or a reconfigurable intelligent surface (RIS)). The network node may perform communication via at least one link between the network node and a wireless communication device (e.g., a UE) or the wireless communication node, according to the SCI.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a network controlled repeater (NCR), in accordance with some embodiments of the present disclosure;

FIG. 4 illustrates an example beam list field, in accordance with some embodiments of the present disclosure;

FIG. 5 illustrates an example forwarding resource field, in accordance with some embodiments of the present disclosure;

FIG. 6 illustrates an example forwarding resource field, in accordance with some embodiments of the present disclosure; and

FIG. 7 illustrates a flow diagram for resource indication, in accordance with an embodiment of the present disclosure.

### DETAILED DESCRIPTION

### 1. Mobile Communication Technology and Environment

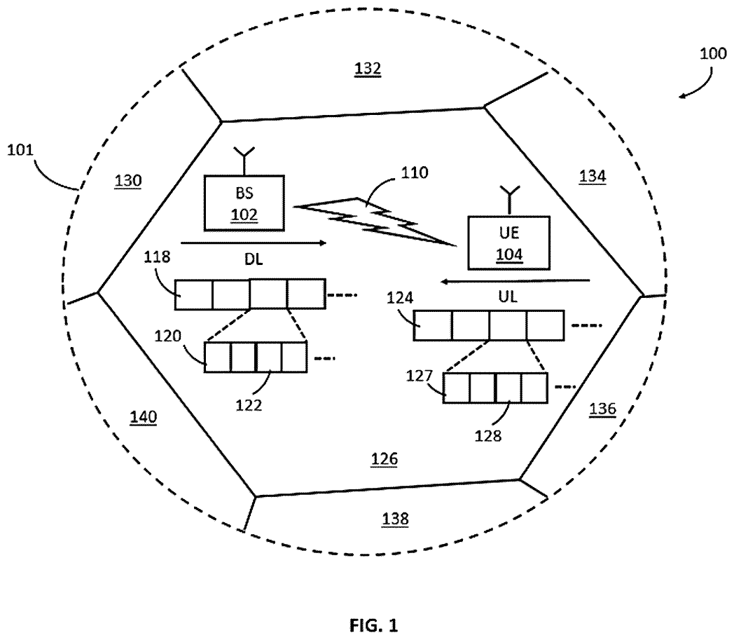

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

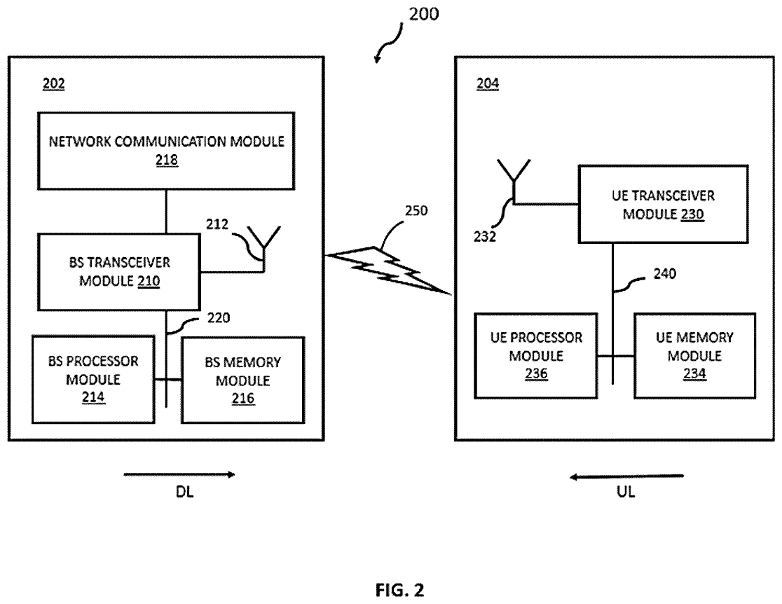

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Resource Indication

As a new radio (NR) system moves to higher frequencies (e.g., around 4 GHz for frequency range 1 (FR1) deployments, above 24 GHz for frequency range 2 (FR2) deployments), propagation conditions degradation as compared to lower frequencies exacerbates coverage challenges. As a result, further densification of cells may be necessary. While a deployment of regular full-stack cells is preferred, the deployment may not always be a possible (e.g., no availability of backhauls) and/or economically viable option. To provide a blanket coverage in cellular network deployments with relatively low cost, radio frequency (RF) repeaters with full-duplex amplify-and-forward operation can be used in 2G, 3G and 4G systems. However, a RF repeater may not be efficient for a 5G NR system, which can use beam management to facilitate directional transmission in the high frequency bands defined for time division duplex (TDD). The RF repeater without beam management functions may not provide suitable beamforming gain in signal forwarding, and may lead to unwanted interference.

To cope/deal/manage with the above problems, a network controlled repeater (NCR) can be considered, which may make use of side control information (SCI) from a BS to enable an intelligent controllable amplify-and-forward operation. The SCI can include beam information and/or an applicable resource, such as beam, time resource, or frequency resource. The NCR (which may sometimes be referred to as a network node, or a smart node/repeater) may use an indicated beam (e.g., indicated according to beam information) and/or the applicable resource (e.g., indicated according to time resource information) to carry out/perform/implement the amplify-and-forward operation(s). If the NCR has multiple panels, panel specific SCI can adopt/include/provide resource information as discussed hereafter.

Furthermore, a reconfigurable intelligent surface (RIS) can also be considered to enable controllable forwarding. In such case, the SCI discussed in this disclosure can be applicable to an RIS as well. The RIS may have a large number of controllable reflection elements, which can be divided into element groups to facilitate efficient control. Each element group's SCI can adopt/include/provide the resource information as discussed hereafter.

In this disclosure, a method for providing resource information via different signaling is proposed for a wireless network using the NCR/RIS. A signaling design is proposed for the SCI of NCRs/RISes. Issues concerned may include one or more of those examples listed below.
Example 1: What kind of signaling can be used to carry the resource information?
Example 2: What is a possible signaling format?
Example 3: How to determine values of L, T, U, F, P, D, G?
Example 4: How to determine actual indicated fields in the signaling?
Example 5: How to determine a bit size per resource indication?
Example 6: How to determine applicable bandwidth part (BWP) for forwarding link (F-link) 1 & 2 (backhaul link)?

RF repeaters can be used in 2G, 3G and 4G deployments to supplement coverage provided by regular full-stack cells with various transmission power characteristics. The RF repeaters may constitute the simplest and most cost-effective way to improve network coverage. The main advantages of RF repeaters can be low-cost, ease of deployment, and the fact that the RF repeaters may not increase latency. The main disadvantage can be that the RF repeaters can amplify signal and noise. Hence, the RF repeaters may contribute to an increase of interference (e.g., signal pollution) in the system. Within RF repeaters, there can be different categories depending on power characteristics and an amount of spectrum that the RF repeaters can be configured to amplify (e.g., single band, or multi-band). The RF repeaters can be a non-regenerative type of relay nodes, and can simply amplify-and-forward signal in an omnidirectional way.

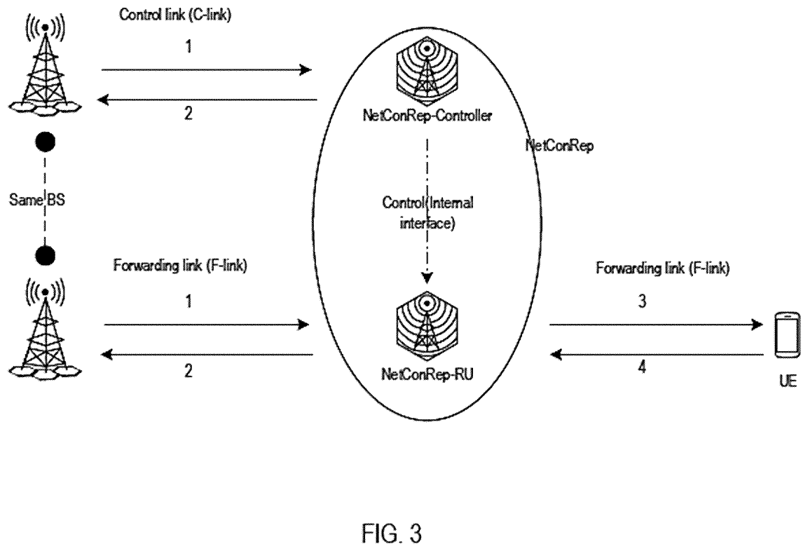

From the perspective of functionality, a general structure of a NCR (e.g., as an alternative/improvement to RF repeaters) is provided in FIG. 3. A NCR-Controller may maintain a control link (C-link) between a BS and a NCR to enable information exchanges (e.g., carrying side control information (SCI)). A NCR-radio unit (RU) may use a forwarding link (F-link), which can refer to an F-link for backhaul (e.g., F-links 1 & 2 or backhaul link) and an F-link for access (e.g., F-links 3 & 4 or access link), to forward data between a BS and UE(s). The behavior of F-link(s) can be controlled according to received SCI from the BS.

The transmission links between the BS to NCR and the NCR to UE as shown in FIG. 3 can be defined/described/provided as follows:
C-link 1: Control link from BS to NCR CU;
C-link 2: Control link from NCR CU to BS;
F-link 1: Forwarding link from BS to NCR FU;
F-link 2: Forwarding link from NCR FU to BS;
F-link 3: Forwarding link from NCR FU to UE; and
F-link 4: Forwarding link from UE to NCR FU.

The forwarding operation on the F-link 1 & 2 (backhaul link) can reuse the resource information and indication mechanism for the C-link. The forwarding operation on the F-link 3 & 4 (access link) may use dedicated resource information and indication mechanism. In this disclosure, a corresponding signaling design is proposed.

To facilitate proper forwarding operation, the resource information for the NCR may include at least one of following indications. The resource information can be applied to beam(s) or link(s), in which a link may include one or more beams with the same forwarding direction.

The beam information may include L (L≥0) beam indications, which can be used to indicate beams to be used in forwarding.

The time information may include T (T≥0) time indications or time resource index, each of which may provide an applicable time for at least one beam or link. In some embodiments, if the time resource index is indicated, T can be equal to 1. The time information may further include U (U≥0) time unit indications, which may each provide a time length of a symbol or a slot applicable for at least one beam or link.

The frequency information may include F (F≥0) frequency indications, which can be applicable frequency resource(s) for at least one beam or link.

The polarization information may include P (P≥0) polarization indications, which can be applicable polarization(s) for at least one beam or link.

The uplink (UL)/downlink (DL)/full duplex (FD) indication may include D (D≥0) direction indications, which can be forwarding direction(s) of at least one beam or link.

The power information may include G (G≥0) power indications, which can be applicable for at least one beam or link.

Two or more of the resource information mentioned above can be indicated jointly (e.g., a resource indication including paired beam and time).

### Implementation Example 1: What Kind of Signaling can be Used to Carry the Resource Information

From the viewpoint of signaling design, the resource information can be carried by at least one of: a radio resource control (RRC) signaling, a medium access control control element (MAC CE) signaling, or a downlink control information (DCI) signaling. Combination of different layer signaling can be possible to save signaling cost.

### Example 1: RRC Only; MAC CE Only

Semi-static or common resource can be configured or indicated via a RRC signaling and/or a MAC CE signaling, which may not change frequently. The major benefit of such an approach is to save dynamic signaling cost. For example, if a common frequency resource is applied for all beams, the common frequency resource can be configured via a RRC signaling and/or a MAC CE signaling.

### Example 2: RRC+MAC CE+DCI; RRC+DCI; MAC CE+DCI

A set of candidate resources can be configured via a RRC signaling. A MAC CE signaling and/or a DCI signaling can be used to select a subset or one of resources from the configured set of candidate resources. The major benefit of this approach is to save signaling cost by converting the resource indication to the resource index (e.g., in the set or the subset) indication. For example, a list of time indications can be configured via a RRC signaling. In some embodiments, a set of time indications can selected from the list via a MAC CE signaling. One of the time indications can be indicated via a DCI signaling from the list or from the selected set. The corresponding time indication index in the list and the set can be used in the MAC CE signaling and the DCI signaling, respectively. For another example, a list of polarizations can be configured via a MAC CE signaling. One of the polarizations can be indicated via a DCI signaling from the list.

### Example 3: DCI Only

Dynamic resource with a limited bit size (e.g., beam indication (e.g., beam index)) can be carried by a DCI signaling. The major benefit is more timely compared to a higher layer signaling. For example, a beam index can be indicated via a DCI signaling for dynamically scheduled forwarding.

### Implementation Example 2: What is a Possible Signaling Format

To correctly decode a signaling, a NCR may need to know a signaling format and a corresponding bit size. A BS may determine a number of resource information (e.g., a number of beams used) in a signaling based on scheduling requirements of the BS per NCR. Multiple NCRs with different scheduling requirements may be connected to the same BS. Therefore, a NCR-specific signaling may be appropriate/needed/utilized (e.g., a DCI with cyclic redundancy check (CRC) scrambled with NCR-specific radio network temporary identifier (RNTI)). Possible DCI formats are proposed as signaling design examples. The formats can also be adopted by a RRC signaling and/or a MAC CE signaling.

### Example 1: Resource Information with Separate Fields

The resource information may comprise a respective field for each indication of the L, T, U, F, P, D, and/or G indications. The resource information can be provided with separate fields as below, which may include L beam indications, T time indications, U time unit indications, F frequency indications, P polarization indications, D direction indications, and/or G power indications.

Beam indication 1
. . .
Beam indication L
Time indication 1
. . .
Time indication T
Time unit 1
. . .
Time unit U
Frequency indication 1
. . .
Frequency indication F
Polarization indication 1
. . .
Polarization indication P
Direction indication 1
. . .
Direction indication D
Power indication 1
Power indication G

### Example 2: Resource Information with Separate List Fields (e.g., a Separate Field for Each Separate List)

The resource information may comprise a respective list for each group. The resource information can be provided with separate lists as below, and each of the lists may include L beam indications, T time indications, U time unit indications, F frequency indications, P polarization indications, D direction indications, and/or G power indications, respectively.
Beam list
Time list
Time unit list
Frequency list
Polarization list
Direction list
Power list

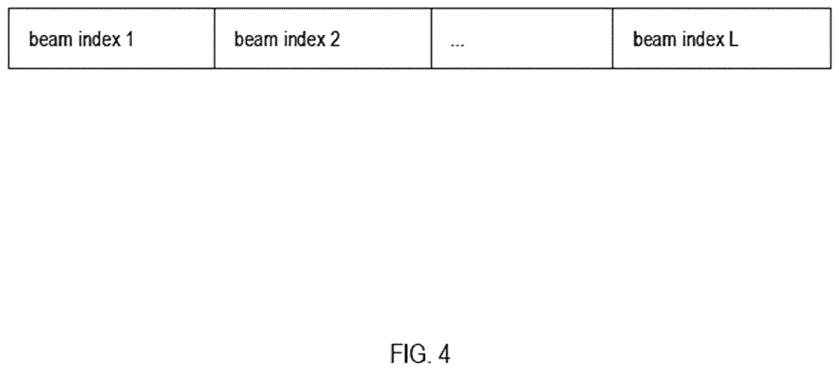

Taking the beam list field as an example, the structure can be a concatenated set of multiple beam indications (e.g., beam indexes) as illustrated in FIG. 4. Other resource lists can adopt the structure of concatenated indications with corresponding numbers of elements (T, U, F, P, D, and G).

### Example 3: Resource Information with Combined Fields

The resource information may comprise a respective group of indications for each of N forwarding resources. The resource information can be provided in groups/pairs. Each forwarding resource may include a group of associated resource indications. A parameter of N forwarding resources can be determined by a maximum value of {L, T, U, F, P, D, G}.

Forwarding resource 1
Forwarding resource 2
. . .
Forwarding resource N_{forwarding} resource

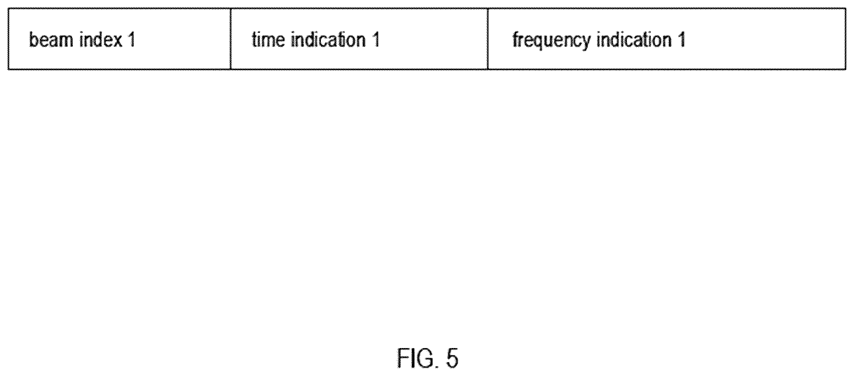

In some embodiments, each forwarding resource may include only the beam, time, and frequency indications. The structure can be a concatenated set/arrangement of different resource indications as illustrated in FIG. 5. FIG. 5 shows an example forwarding resource field of forwarding resource 1.

### Example 4: Resource Information with Combined Fields and Separate Fields

The forwarding resource in Example 3 and the separate fields in Example 1 can be used together in a signaling format. For example, time unit, frequency indication, polarization indication, direction indication and power indication can be common for all beams. These common resource information can be provided in separate fields to reduce the signaling cost. For example, the forwarding resource field may include beam and time information. The parameter N_{forwarding} resource can be determined by the maximum value of {L, T}. The other resources can be provided in separate fields.

Forwarding resource 1
Forwarding resource 2
. . .
Forwarding resource N_{forwarding} resource
Time unit
Frequency indication
Polarization indication
Direction
Power indication

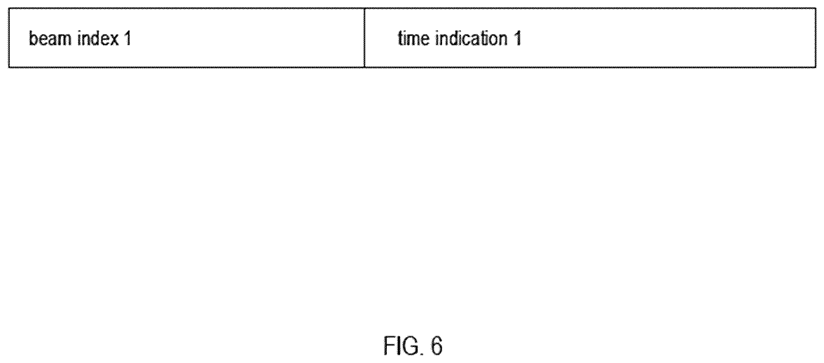

The structure of the forwarding resource 1 is illustrated in FIG. 6 as an example.

### Implementation Example 3: How to Determine Values of L, T, U, F, P, D, and G

### Example 1: Determination of the Number of Beam Indications, L

Beam information may comprise L indications each to indicate a respective beam to be used in forwarding. L can be an integer value greater than or equal to 0.

(1) L can be a fixed or common configurable for all NCRs. For example, L=4 can be a predefined value or a common configuration for all NCRs. The benefit is that no NCR-specific configuration is needed.

If NCR 1 has only 2 beams, the first 1˜2 beam indication fields can be used in a DCI signaling. The NCR1 may ignore/disregard the last 2 beam indication fields, which may be filled with dummy bits by the BS.

If NCR 2 has 8 beams, at most 4 beams can be indicated in a DCI signaling.

(2) L can be a configurable value per NCR. The benefit is that the L value can be set properly to fit the NCR's capability.

If NCR 1 has at least 4 beams, L=4 can be configured for the NCR 1. At most 4 beams can be indicated to the NCR 1 in a DCI signaling.

If NCR 2 has at least 8 beams, L=8 can be configured for the NCR 2. At most 8 beams can be indicated to the NCR 2 in a DCI signaling.

(3) L can be zero, which may mean/indicate/represent that the beam field does not exist in the RRC/MAC CE/DCI signaling. In such case, the beam to be used can be implicitly indicated by other resource information field(s).

For example, the NCR 1 may have 8 beams with indexes {1, 2 . . . 8}. The BS may only use the beams {1, 2 . . . 4} to provide service for a coverage hole. Therefore, the BS/OAM may configure a fixed beam pattern of {1, 2 . . . 4} to the NCR 1. The number of beams (e.g., L_{beam}) in the beam pattern can be 4. L_{beam} may indicate/mean a fixed value for both the BS and the NCR. Since the fixed value does not change until a new configuration applied by the BS/OAM, the fixed value can be omitted in the SCI. These 4 beams may be used in the forwarding if corresponding time indication is valid. Other field (e.g., a beam enable/disable bitmap) can also be added in the DCI signaling to indicate the used beams. The benefit is that no beam indication field may be needed in the DCI signaling.

### Example 2: Determination of the Number of Time Indications, T

Time information may comprise T indications each to indicate a respective applicable time for at least one beam. T can be an integer value greater than or equal to 0.

(1) T=L (L≠0) or T=L_{beam}, which may mean/indicate/represent that a 1-to-1 mapping is used to associate the beam and the time. This mapping is a simple way to provide an applicable time of each beam.

(2) T=1. In some embodiments, the T=1 can mean/indicate/represent a time resource index corresponding to a time resource, which includes at least one time indication. A list of time resources can be preconfigured to the NCR via a RRC and/or MAC CE signaling. An example of the time resource list is provided below (Table 1). Each time resource may have a different number of time indications.

TABLE 1

| Time | | |
|---|---|---|
| resource | | |
| index | Time resource | Note |
| 0 | [applicable time 1, applicable time 2, | The 0^{th} time resource may |
| | applicable time 3, applicable time 4] | include 4 time indications. |
| 1 | [applicable time 1′, applicable time 2′, | The 1^{st} time resource may |
| | applicable time 3′, applicable time 4′] | include 4 time indications. |
| 2 | [applicable time 1″, | The 2^{nd} time resource may |
| | applicable time 2″] | include 2 time indications. |
| 3 | [applicable time 1′″, | The 3^{rd} time resource may |
| | applicable time 2′″] | include 2 time indications. |

In some embodiments, the T=1 can mean/indicate/represent that a L-to-1 mapping is used to associate the beam and the time. This mapping can be used as a special case, if the NCR supports simultaneous beams during the same applicable time (e.g., FDMed or SDMed beams).

(3) T=0, which may mean/indicate/represent that the time can be implicitly indicated by the DCI signaling itself. The beam indication may take effect upon the reception of the DCI signaling. The beam may change with the reception of another DCI signaling.

### Example 3: Determination of the Number of Time Unit Indications, U

Time unit information may comprise U indications each to indicate a respective time length of a symbol or a slot applicable for at least one beam. U can be an integer value greater than or equal to 0.

(1) U=1, which may mean/indicate/represent that a common time unit (e.g., the same symbol length) is applicable for all beams indicated in the DCI.

(2) U=0, which May Mean/Indicate/Represent that a Time Unit is not Indicated in the DCI signaling, but which can be fixed or preconfigured via a RRC or MAC CE signaling, or indicated from operations, administration, and maintenance (OAM).

(3) U=L (L≠0) or U=L_{beam}, which may mean/indicate/represent that a 1-to-1 mapping is used to associate the beam and the time unit. For example, multiple beams may use different carrier frequencies (e.g., in FR1 and FR2) and corresponding different symbol lengths.

(4) 0<U<L (L≠0) or L_{beam}, which may mean/indicate/represent that some (but not all) beams share the same time unit. In such case, the beams using the same time unit may be listed under the corresponding time unit.

### Example 4: Determination of the Number of Frequency Indications, F

Frequency information may comprise F indications each to indicate a respective applicable frequency resource for at least one beam. F can be an integer value greater than or equal to 0.

(1) F=L (L≠0) or F=L_{beam}, which may mean/indicate/represent a 1-to-1 mapping is used to associate the beam and the frequency (frequency resource). This mapping can be a simple way to provide the applicable frequency resource of each beam.

(2) F=1, which may mean/indicate/represent that an L-to-1 mapping is used to associate the beam and the frequency. This mapping can be used as a special case (e.g., a common frequency bandwidth is used in the forwarding operation).

(3) F=0, which may mean/indicate/represent that the frequency indication is implicitly determined by BS/OAM with a fixed supported or fixed configured frequency resource (e.g., a system bandwidth).

(4) 0<F<L (L≠0) or L_{beam}, which may mean/indicate/represent some (but not all) beams share the same frequency resource. In such case, the beams using the same frequency resource may be listed under the corresponding frequency indication.

### Example 5: Determination of the Number of Polarization Indications, P

Polarization information may comprise P indications each to indicate a respective applicable polarization for at least one beam. P can be an integer value greater than or equal to 0.

(1) P=L (L≠0) or P=L_{beam}, which may mean/indicate/represent that a 1-to-1 mapping is used to associate the beam and the polarization.

(2) P=1, which may mean/indicate/represent that a L-to-1 mapping is used to associate the beam and the polarization. This mapping can be used as a special case (e.g., a common polarization is used in the forwarding operation).

(3) P=0, which may mean/indicate/represent that the polarization indication can be implicitly determined by a BS/OAM with a fixed supported or fixed configured polarization (e.g., one of {linear, cross, right-hand circular polarized (RHCP), left-hand circular polarized (LHCP)}).

(4) 0<P<L (L≠0) or P=L_{beam}, which may mean/indicate/represent that some (but not all) beams share the same polarization. In such case, the beams using the same polarization may be listed under the corresponding polarization indication.

### Example 6: Determination of the Number of Direction Indications, D

Forwarding direction information may comprise D indications each to indicate a respective forwarding direction of at least one beam. D can be an integer value greater than or equal to 0.

(1) D=L (L≠0) or D=L_{beam}, which may mean/indicate/represent that a 1-to-1 mapping is used to associate the beam and the forwarding direction.

(2) D=1, which may mean/indicate/represent that a L-to-1 mapping is used to associate the beam and the forwarding direction. This mapping can be used as a special case (e.g., a common direction is used in the forwarding operation).

(3) D=0, which may mean/indicate/represent that the direction indication can be implicitly determined (e.g., by a BS/OAM with a fixed TDD configuration).

(4) 0<D<L (L≠0) or L_{beam}, which may mean/indicate/represent that some (but not all) beams share the same forwarding direction. In such case, the beams using the same direction may be listed under the corresponding direction indication.

### Example 7: Determination of the Number of Power Indications, G

Power information may comprise G indications each to indicate a respective forwarding power of at least one beam. G can be an integer value greater than or equal to 0.

(1) G=L (L≠0) or G=L_{beam}, which may mean/indicate/represent that a 1-to-1 mapping is used to associate the beam and the power indication.

(2) G=1, which may mean/indicate/represent that a L-to-1 mapping is used to associate the beam and the power indication. This mapping can be used as a special case (e.g., a common power indication is used in the forwarding operation).

(3) G=0, which may mean/indicate/represent that the power indication is not included in the DCI, which can be determined by implementation or be configured by a BS/OAM.

(4) 0<G<L (L≠0) or L_{beam}, which may mean/indicate/represent some (but not all) beams share the same power indication. In such case, the beams using the same power indication may be listed under the corresponding power indication.

### Implementation Example 4: How to Determine Actual Indicated Fields (for SCI) in the Signaling

The parameters/values L, T, U, F, P, D, and/or G can be determined by using the methods in the Implementation Example 3. With these parameters, the DCI bit size can be known for NCR's decoding. However, the NCR may know/be aware of actual indicated beam number L1 (L1≤L or L1≤L_{beam}) and the associated other resource(s) to carry out forwarding operation. The following methods may determine the value of L1.

### Example 1: L1 is Determined Implicitly by the Time Information

If T=L (L≠0) or T=L_{beam}, the actual indicated beam number L1 can be determined by time information implicitly. The first L1 beam indications can be provided with corresponding L1 number of time indications. For the remaining/following (L-L1) beam indications, the corresponding (L-L1) time indications can be invalid (only first L1 time indications can be used/valid). For example, the last (L-L1) time indications can have the same start time and end time, which may mean/indicate that a duration is zero. For another example, the last (L-L1) time indications can have an invalid value (e.g., zero or out-of-range values) for the duration.

If T=1, and the time information is the time resource index as described in the Implementation Example 3, Example 2. The actual indicated beam number L1 can be determined by the number of time indications in the selected time resource by the gNB.

### Example 1a: A Field of Actual Indicated Time Number is Added in the DCI Signaling

A field of actual indicated time number T1 can be added in the same DCI signaling. The bit size for T1 equals to ┌log₂T┐. The first L1 (L1=T1) beam indication can be valid. The T1 can be provided via other signaling (e.g., a RRC signaling or a MAC CE signaling).

### Example 2: A Field of Actual Indicated Beam Number is Added in the DCI Signaling

A field of actual indicated beam number L1 can be added in the same DCI signaling. The bit size for L1 equals to ┌log₂L┐. The first L1 beam indication can be valid. The L1 can be provided via other signaling (e.g., a RRC signaling or a MAC CE signaling).

### Example 3: L=0 and a Beam Enable/Disable Bitmap is Added in the DCI Signaling

A beam enable/disable bitmap can be added in the same DCI signaling if a fixed beam pattern with L_{beam} beams is configured for an NCR. The bit size for the bitmap can be L_{beam} bits. Each bit in the bitmap may correspond to one of the L_{beam} beams. A “1” bit may mean/indicate that the beam is enabled. A “0” bit may mean/indicate that the beam is disabled.

### Example 4: L1 is Determined by the Invalid Beam Index

If the NCR has 10 beams, 4 bits (=log₂10) (for up to 16 beam indication values) may be needed to index/indicate that the beams and the value of [0, 1, . . . , 9] are valid. In a DCI signaling, at most 10 valid beams can be indicated by the BS. The NCR may ignore/disregard the last 6 beam indication due to the NCR's capability. The first L1 beam indication may include the valid beam index. For the following 10-L1 beam indication, an invalid beam index of 15 can be used for instance.

### Implementation Example 5: How to Determine a Bit Size Per Resource Indication

A whole bit size of the DCI signaling can be determined by (1) the parameters/values L, T, U, F, P, D, and/or G, and (2) the bit size per resource indication. The bit size per resource indication may depend on the resource format, which is elaborated below.

### Example 1: Bit Size Per Beam Indication

The beam indication can be a beam index or other equivalent index, such as a reference signal (RS) index, a spatial filter index, or a transmission configuration indicator (TCI) state ID. The bit size per beam indication can be determined by the number of beams of the NCR. For example, the NCR may have 16 beams, and the bit size per beam indication can be 4 bits (=┌log₂16┐).

### Example 2: Bit Size Per Time Indication

The applicable time can be at least one of following formats: (1) start time+end time, for beam(s); (2) start time+duration, for beam(s); (3) start time+duration1+duration2+ . . . +durationL, for multiple beams with consecutive applicable time and negligible beam switching time; (4) start and length indicator (SLIV), for beam(s); or (5) time indication index, for beam(s) based on configured time indications. In some embodiments, the start time can include a start slot and/or a start symbol, which may depend on the hierarchical time units defined in the communication system. Similarly, the end time can include an end slot and/or an end symbol. The duration can include a number of consecutive slots and/or a number of consecutive symbols. In an NR system, a frame of 10 ms may include 10 slots if 15 kHz subcarrier spacing (SCS) is used. If the start/end slot ranges in a frame (e.g., [0, 1, . . . , 9]), the start/end slot may utilize 4 bits (=┌log₂10┐). If the start/end symbol ranges in a slot (e.g., [0, 1, . . . , 13]), the start/end symbol may utilize 4 bits (=┌log₂14┐). If the duration in unit of symbol ranges in a frame (e.g., [0, 1, . . . , 139]), the duration may need/utilize 8 bits (=┌log₂140┐). In some embodiments, the SLIV can be inherited from a defined definition, which can be not longer than a slot and may use 7 bits. Similar method can be used to define a slot level SLIV.

As mentioned in the Implementation Example 1, different layer signaling can be used to carry the SCI. In the Implementation Example 1, Example 2, if 16 time indications are preconfigured via a RRC signaling, one of the time indications (or time indication indexes) can be indicated/identified via a DCI signaling. The corresponding time indication index can be used in a DCI signaling, which may utilize 4 bits (=┌log₂16┐).

### Example 3: Bit Size Per Time Unit Indication

The time unit may determine the absolute time length of forwarding operation. The time unit can be calculated using a reference subcarrier spacing (SCS) (e.g., 1/SCS) or directly given by an absolute time length (e.g., 1 ms).

For example, a reference SCS can be provided in the time information. An enumerated type with values of {scs15 or 60, scs30 or 120} in master information block (MIB) can be reused. In this example, the bit size can be 1 bit (=┌log₂2┐). The time unit can be calculated as 1/SCS depending on the carrier in FR1 or FR2. For another example, if a reference SCS is determined by a default (or configured) SCS (e.g., the SCS used by the C-link), the time unit can be omitted in the time information. The corresponding bit size can be 0. For another example, an absolute time length can be provided in the time information. An enumerated type with values of {0.125 ms, 0.25 ms, 0.5 ms, 1 ms} can be used. In this example, the bit size can be 2 bit (=┌log₂4┐).

### Example 4: Bit Size Per Frequency Indication

The frequency resource can be at least one of following formats: (1) logical index of frequency band (e.g., a carrier or BWP); (2) start physical resource block (PRB)+end PRB; (3) start PRB+number of consecutive PRBs; or (4) frequency domain resource assignment in current DCI (e.g., resource indication value (RIV)). In an NR system, N_{BWP} (e.g., an integer number of) dedicated BWPs can be configured per NCR. For example, if N_{BWP}=4, 2 bits may be utilized/used for the BWP index. Similarly, the bit size can be determined if multiple carriers are configured. The bit size of the start PRB, the end PRB and the number of consecutive PRBs can be determined by the PRB number in the system bandwidth. In addition, the start PRB and the end PRB can be presented by an offset from the Point A. The frequency domain resource assignment in the DCI format 0_0 of the NR system can be reused. The bit size is ┌log₂(N_{PRB} (N_{PRB}+1)/2)┐, where N_PRB is the PRB number of a configured bandwidth (e.g., the system bandwidth or a BWP).

### Example 5: Bit Size Per Polarization Indication

The bit size used by the polarization information can be determined by the value of P and the supported polarization mode of the NCR. For example, if the NCR supports the polarization mode of {linear, cross, RHCP right hand circular polarization, LHCP left hand circular polarization}, 2 bits may be utilized.

### Example 6: Bit Size Per Direction Indication

The bit size used by the direction information can be determined by the value of D and the supported duplexing mode of the NCR. For example, if the NCR supports full duplexing, the direction can be {UL, DL, FD} and 2 bits can be utilized. If the NCR does not support full duplexing, the direction can be {UL, DL} and 1 bit can be utilized.

### Example 7: Bit Size Per Power Indication

The power indication can be at least one of following formats: (1) transmission power, for beam(s); (2) amplifying gain, for beam(s); or (3) delta value of transmission power or amplifying gain. The transmission power of the NCR can be indicated by the BS. The NCR may derive the amplifying gain by the formula: amplifying gain=transmission power/input power. The bit size of transmission power can be determined by the value range. For example, if the value range is INTEGER (−16 . . . 15), 5 bits can be utilized. The amplifying gain can be indicated by the BS. The NCR's transmission power can be calculated as: transmission power=min(max power, input power*amplifying gain), where “*” means multiplication in linear domain. The bit size of amplifying gain can be determined by the value range. For example, if the value range is INTEGER (0 . . . 31), 5 bits can be utilized. If the delta value of transmission power is indicated, the new transmission power of the NCR can be calculated as: transmission power_new=min(max power, transmission power_old+delta value_power), where “+” means addition in logarithm domain with a delta value_power in unit of dB. If the delta value of amplifying gain is indicated, the new amplifying gain of the NCR can be calculated as: amplifying gain_new=amplifying gain_old+delta value_gain, where “+” means addition in logarithm domain with a delta value_gain in unit of dB. In some embodiments, the new transmission power may not exceed max power. The bit size of delta value can be determined by its value range. For example, if the delta value's value range is INTEGER (−16 . . . 15), 5 bits can be utilized.

The forwarding operation on the F-link 1&2 (backhaul link) can reuse the resource information and indication mechanism for the C-link. Hereafter, the corresponding signaling design is proposed.

### Implementation Example 6: How to Determine Applicable Bandwidth Part (BWP) for Forwarding Links (F-Links) 1 & 2 (Backhaul Link)

The forwarding operation on the F-links 1 & 2 (backhaul link) can reuse the resource information and indication mechanism for the C-link. A corresponding signaling design is proposed.

A NCR controller may receive SCI from a BS via a C-link. The resource information and indication mechanism for the C-link can use a RRC, MAC CE, and DCI signaling. For example, a RRC signaling can be used to configure at least one of TCI state list/spatial relation list/unified TCI state list for beam indication on the C-link. The MAC CE signaling and/or the DCI signaling can be used to select (or activate/deactivate) one or more TCI states/spatial relation/unified TCI states. Since the F-link 1 & 2 (backhaul link) and the C-link shares the same communication condition, the RRC configured TCI state list/spatial relation list/unified TCI states list for the C-link can be reused by the F-links 1 & 2 (backhaul link).

However, for the F-links 1 & 2 (backhaul link), a new MAC CE (different from the one used for the C-link) can be utilized to select (or activate/deactivate) one or more TCI states/spatial relation/unified TCI states. Regarding the DL and/or UL BWP applicable for the new MAC CE, following options are proposed.

### Example 1: How to Determine a DL BWP Applicable for the New MAC CE

In some embodiments, the DL BWP can be an active DL BWP.

In some embodiments, the DL BWP can be an initial DL BWP.

In some embodiments, the DL BWP can be a first active DL BWP configured via a RRC signaling (e.g., firstActiveDownlinkBWP-Id).

In some embodiments, the DL BWP can be a default DL BWP configured via a RRC signaling (e.g., defaultDownlinkBWP-Id).

In some embodiments, a dedicated field can be defined in a new MAC CE signaling to indicate the DL BWP as a codepoint of a DCI bandwidth part indicator field.

In some embodiments, a dedicated field (e.g., a bit flag) may indicate whether the DL BWP is the active DL BWP or the initial DL BWP. For example, the value of 0 may mean/indicate the initial DL BWP. The value of 1 may mean/indicate the active DL BWP.

### Example 2: How to Determine a UL BWP Applicable for the New MAC CE

In some embodiments, the UL BWP can be an active UL BWP.

In some embodiments, the UL BWP can be an initial UL BWP.

In some embodiments, the UL BWP can be a first active UL BWP configured via a RRC signaling (e.g., firstActiveUplinkBWP-Id).

In some embodiments, a dedicated field can be defined in the new MAC CE to indicate the UL BWP as a codepoint of the DCI bandwidth part indicator field.

In some embodiments, a dedicated field (e.g., a bit flag) may indicate whether the UL BWP is the active UL BWP or the initial UL BWP. For example, the value of 0 may mean/indicate the initial UL BWP. The value of 1 may mean/indicate the active UL BWP.

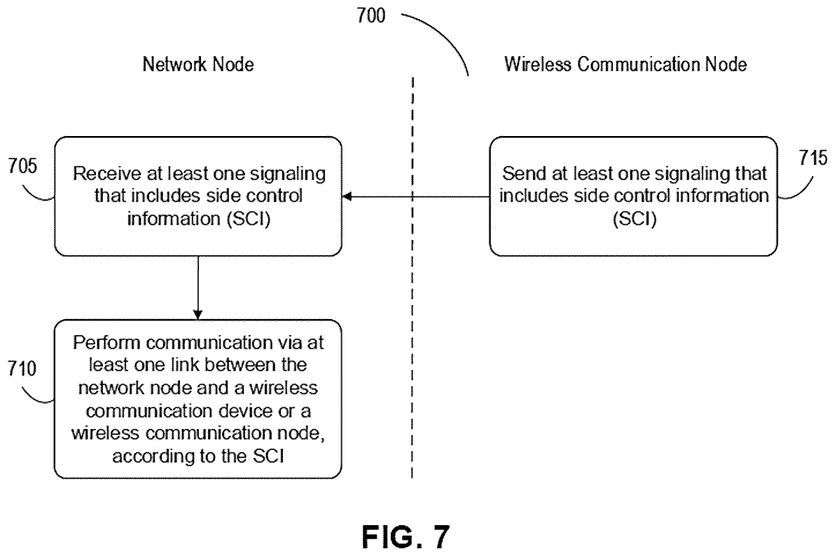

FIG. 7 illustrates a flow diagram of a method 700 for resource indication. The method 700 may be implemented using any one or more of the components and devices detailed herein in conjunction with FIGS. 1-2. In overview, the method 700 may be performed by a network node, in some embodiments. Additional, fewer, or different operations may be performed in the method 700 depending on the embodiment. At least one aspect of the operations is directed to a system, method, apparatus, or a computer-readable medium.

A network node (e.g., a network controlled repeater (NCR), a reconfigurable intelligent surface (RIS)) may receive at least one signaling that includes side control information (SCI) from a wireless communication node (e.g., a base station (BS)). The network node may perform communication (e.g., transmission and/or reception) via at least one link between the network node and a wireless communication device (e.g., a user equipment (UE)) or the wireless communication node, according to the SCI. The at least one link may include at least one of: a first forwarding link from the wireless communication node to the network node; a second forwarding link from the network node to the wireless communication node; a third forwarding link from the network node to the wireless communication device; or a fourth forwarding link from the wireless communication device to the network node.

In some embodiments, the SCI may comprise at least one of: beam information comprising L indications each to indicate a respective beam to be used in forwarding, where L is an integer value greater than or equal to 0; time information comprising T indications each to indicate a respective applicable time for at least one beam, where T is an integer value greater than or equal to 0; time unit information comprising U indications each to indicate a respective time length of a symbol or a slot applicable for at least one beam, where U is an integer value greater than or equal to 0; frequency information comprising F indications each to indicate a respective applicable frequency resource for at least one beam, where F is an integer value greater than or equal to 0; polarization information comprising P indications each to indicate a respective applicable polarization for at least one beam, where P is an integer value greater than or equal to 0; forwarding direction information comprising D indications each to indicate a respective forwarding direction of at least one beam, where D is an integer value greater than or equal to 0; or power information comprising G indications each to indicate a respective forwarding power of at least one beam, where G is an integer value greater than or equal to 0.

In some embodiments, the at least one signaling may comprise at least one of: a radio resource control (RRC) signaling, a medium access control control element (MAC CE) signaling, or a downlink control information (DCI) signaling. A first format of the at least one signaling may comprise: a respective field for each indication of the L, T, U, F, P, D and G indications. A second format of the at least one signaling may comprise: a respective list for each group of the L indications, the T indications, the U indications, the F indications, the P indications, the D indications, and the G indications, respectively.

In some embodiments, a third format of the at least one signaling may comprise: a respective group of indications for each of N forwarding resources. N can be an integer value corresponding to a maximum value amongst L, T, U, F, P, D and G. Each of the groups of indications may include a respective indication from each of at least one of: the L indications, the T indications, the U indications, the F indications, the P indications, the D indications, or the G indications.

In some embodiments, a fourth format of the at least one signaling may comprise at least one of: a respective field for each indication of at least some of the L, T, U, F, P, D and G indications; or a respective group of indications for each of at least some of N forwarding resources. N can be an integer value corresponding to a maximum value amongst any two or more of L, T, U, F, P, D and G. Each of the groups of indications may include a respective indication from each of at least one of: the L indications, the T indications, the U indications, the F indications, the P indications, the D indications, or the G indications.

In some embodiments, L can be an integer value that is: defined or configured for a plurality of network nodes; defined or configured according to a capability of the network node; or equal to zero.

In some embodiments, T=L, which may represent a 1-to-1 mapping to associate each beam with a respective applicable time; T=1, which may represent a L-to-1 mapping to associate the L beams with a common time, or which may have a time resource index indicating at least one applicable time; or T=0.

In some embodiments, U=1, which may represent a L-to-1 mapping to associate the L beams with a common time unit; U=0; or U=L, which may represent a 1-to-1 mapping to associate each beam with a respective applicable time unit.

In some embodiments, F=L, which may represent a 1-to-1 mapping to associate each beam and with a respective applicable frequency; F=1, which may represent a L-to-1 mapping to associate the L beams with a common frequency; F=0; or 0<F<L, which may represent associating a common frequency resource with some of the L beams.

In some embodiments, P=L, which may represent a 1-to-1 mapping to associate each beam with a respective applicable polarization; P=1, which may represent a L-to-1 mapping to associate the L beams with a common polarization; P=0; or 0<P<L, which may represent associating a common polarization with some of the L beams.

In some embodiments, D=L, which may represent a 1-to-1 mapping to associate each beam with a respective applicable forwarding direction; D=1, which may represent a L-to-1 mapping to associate the L beams with a common forwarding direction; D=0; or 0<D<L, which may represent associating a common forwarding direction with some of the L beams.

In some embodiments, G=L, which may represent a 1-to-1 mapping to associate each beam with a respective applicable power indication; G=1, which may represent a L-to-1 mapping to associate the L beams with a common power indication; G=0; or 0<G<L, which may represent associating a common power indication with some of the L beams.

In some embodiments, the network node may determine an actual number of beams (L1), according to: (i) a number of time indications that are determined to be valid, or (ii) a number of applicable times indicated by a time resource index. The network node may determine an actual number of beams (L1), according to a radio resource control (RRC) or medium access control control element (MAC CE) signaling. The network node may determine an actual number of time (T1), according to a radio resource control (RRC) or medium access control control element (MAC CE) signaling.

In some embodiments, a wireless communication node (e.g., a BS) may send at least one signaling that includes side control information (SCI) to a network node (e.g., a network controlled repeater (NCR), or a reconfigurable intelligent surface (RIS)). The network node may perform communication via at least one link between the network node and a wireless communication device (e.g., a UE) or the wireless communication node, according to the SCI.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a network node, from a wireless communication node, at least one signaling that includes side control information (SCI); and
performing, by the network node, communication via at least one link between the network node and a wireless communication device or the wireless communication node, according to the SCI.

2. The method of claim 1, wherein the at least one link includes at least one of:
a first forwarding link from the wireless communication node to the network node;
a second forwarding link from the network node to the wireless communication node;
a third forwarding link from the network node to the wireless communication device; or
a fourth forwarding link from the wireless communication device to the network node.

3. The method of claim 1, wherein the SCI comprises at least one of:
beam information comprising L indications each to indicate a respective beam to be used in forwarding, where L is an integer value greater than or equal to 0;
time information comprising T indications each to indicate a respective applicable time for at least one beam, where T is an integer value greater than or equal to 0;
time unit information comprising U indications each to indicate a respective time length of a symbol or a slot applicable for at least one beam, where U is an integer value greater than or equal to 0;
frequency information comprising F indications each to indicate a respective applicable frequency resource for at least one beam, where F is an integer value greater than or equal to 0;
polarization information comprising P indications each to indicate a respective applicable polarization for at least one beam, where P is an integer value greater than or equal to 0;
forwarding direction information comprising D indications each to indicate a respective forwarding direction of at least one beam, where D is an integer value greater than or equal to 0; or
power information comprising G indications each to indicate a respective forwarding power of at least one beam, where G is an integer value greater than or equal to 0.

4. The method of claim 1, wherein the at least one signaling comprises at least one of: a radio resource control (RRC) signaling, a medium access control control element (MAC CE) signaling, or a downlink control information (DCI) signaling.

5. The method of claim 3, wherein a first format of the at least one signaling comprises: a respective field for each indication of the L, T, U, F, P, D and G indications.

6. The method of claim 3, wherein a second format of the at least one signaling comprises: a respective list for each group of the L indications, the T indications, the U indications, the F indications, the P indications, the D indications, and the G indications, respectively.

7. The method of claim 3, wherein a third format of the at least one signaling comprises: a respective group of indications for each of N forwarding resources, wherein at least one of:
N is an integer value corresponding to a maximum value amongst L, T, U, F, P, D and G; or
each of the groups of indications includes a respective indication from each of at least one of: the L indications, the T indications, the U indications, the F indications, the P indications, the D indications, or the G indications.

8. The method of claim 3, wherein a fourth format of the at least one signaling comprises at least one of:
a respective field for each indication of at least some of the L, T, U, F, P, D and G indications; or
a respective group of indications for each of at least some of N forwarding resources, wherein at least one of:
N is an integer value corresponding to a maximum value amongst any two or more of L, T, U, F, P, D and G; or
each of the groups of indications includes a respective indication from each of at least one of: the L indications, the T indications, the U indications, the F indications, the P indications, the D indications, or the G indications.

9. The method of claim 3, wherein L is an integer value that is:
defined or configured for a plurality of network nodes;
defined or configured according to a capability of the network node; or
equal to zero.

10. The method of claim 3, wherein one of:
T=L, which represents a 1-to-1 mapping to associate each beam with a respective applicable time;
T=1, which represents a L-to-1 mapping to associate the L beams with a common time, or which has a time resource index indicating at least one applicable time; or
T=0.

11. The method of claim 3, wherein one of:
U=1, which represents a L-to-1 mapping to associate the L beams with a common time unit;
U=0; or
U=L, which represents a 1-to-1 mapping to associate each beam with a respective applicable time unit.

12. The method of claim 3, wherein one of:
F=L, which represents a 1-to-1 mapping to associate each beam and with a respective applicable frequency;
F=1, which represents a L-to-1 mapping to associate the L beams with a common frequency;
F=0; or
0<F<L, which represents associating a common frequency resource with some of the L beams.

13. The method of claim 3, wherein one of:
P=L, which represents a 1-to-1 mapping to associate each beam with a respective applicable polarization;
P=1, which represents a L-to-1 mapping to associate the L beams with a common polarization;
P=0; or
0<P<L, which represents associating a common polarization with some of the L beams.

14. The method of claim 3, wherein one of:
D=L, which represents a 1-to-1 mapping to associate each beam with a respective applicable forwarding direction;
D=1, which represents a L-to-1 mapping to associate the L beams with a common forwarding direction;
D=0; or
0<D<L, which represents associating a common forwarding direction with some of the L beams.

15. The method of claim 3, wherein one of:
G=L, which represents a 1-to-1 mapping to associate each beam with a respective applicable power indication;
G=1, which represents a L-to-1 mapping to associate the L beams with a common power indication;
G=0; or
0<G<L, which represents associating a common power indication with some of the L beams.

16. The method of claim 3, the method further comprises:
determining, by the network node, an actual number of beams (L1), according to: (i) a number of time indications that are determined to be valid, or (ii) a number of applicable times indicated by a time resource index.

17. The method of claim 3, comprising:
determining, by the network node, an actual number of beams (L1), according to a radio resource control (RRC) or medium access control control element (MAC CE) signaling; or
determining, by the network node, an actual number of time (T1), according to a radio resource control (RRC) or medium access control control element (MAC CE) signaling.

18. A network node, comprising:
at least one processor configured to:
receive, via a transceiver from a wireless communication node, at least one signaling that includes side control information (SCI); and
perform communication, via the transceiver, via at least one link between the network node and a wireless communication device or the wireless communication node, according to the SCI.

19. A method comprising:
sending, by a wireless communication node to a network node, at least one signaling that includes side control information (SCI),
wherein the network node performs communication via at least one link between the network node and a wireless communication device or the wireless communication node, according to the SCI.

20. A wireless communication node, comprising:
at least one processor configured to:
send, via a transmitter to a network node, at least one signaling that includes side control information (SCI),
wherein the network node performs communication via at least one link between the network node and a wireless communication device or the wireless communication node, according to the SCI.
